(19) United States
(12) Patent Application Publication
(10) Pub. No.: US 2024/0193310 A1
(43) Pub. Date: Jun. 13, 2024

(54) MEDIA ACCESS CONTROL CIRCUIT AND PACKET MANAGEMENT METHOD

(71) Applicant: SigmaStar Technology Ltd., Xiamen (CN)

(72) Inventors: Qin-Wei She, Shanghai (CN); Yan-Xiong Wu, Shanghai (CN); Shi-Xiang Zheng, Shanghai (CN)

(21) Appl. No.: 18/381,189

(22) Filed: Oct. 18, 2023

(30) Foreign Application Priority Data
Dec. 8, 2022 (CN) 202211574661.6

(51) Int. Cl. G06F 21/75

(52) U.S. Cl. CPC G06F 21/75

(57) ABSTRACT

A media access control (MAC) circuit is coupled to a physical layer circuit and includes a storage circuit, a receiving circuit, a checking circuit, and a protection circuit. The storage circuit is configured to store a first value and a second value. The receiving circuit is configured to receive a packet from the physical layer circuit. The checking circuit is configured to check the packet. The protection circuit is configured to perform the following steps: updating the first value according to a clock; and discarding the packet when the absolute difference between the first value and a reference value is smaller than the second value.

This application claims the benefit of China application Serial No. 202211574661.6, filed on Dec. 8, 2022, the subject matter of which is incorporated herein by reference.

### BACKGROUND OF THE INVENTION

### 1. Field of the Invention

The present invention generally relates to networks, and, more particularly, to media access control (MAC) circuits and packet management methods.

### 2. Description of Related Art

FIG. 1 shows a conventional electronic device. The main circuit 110 receives packets from a network 150 (e.g., Ethernet) or sends packets to the network 150 via the MAC circuit 120, the physical layer circuit 130, and the transformer 140. However, under certain conditions (e.g., when the device fails or is under attack), the electronic device may receive a large number of packets, resulting in an increased load on the main circuit 110, which in turn results in a poor user experience or even malfunction of the electronic device.

### SUMMARY OF THE INVENTION

In view of the issues of the prior art, an object of the present invention is to provide a media access control (MAC) circuit and a packet management method, so as to make an improvement to the prior art.

According to one aspect of the present invention, a MAC circuit is provided. The MAC circuit coupled to a physical layer circuit and includes a storage circuit, a receiving circuit, a checking circuit, and a protection circuit. The storage circuit is configured to store a first value and a second value. The receiving circuit is configured to receive a packet from the physical layer circuit. The checking circuit is configured to check the packet. The protection circuit is configured to perform following steps: updating the first value according to a clock; and discarding the packet when an absolute difference between the first value and a reference value is smaller than the second value.

According to another aspect of the present invention, a packet management method is provided. The packet management method is applied to a MAC circuit. The MAC circuit is coupled to a physical layer circuit and includes a storage circuit that stores a first value, a second value, and a reference value. The method includes the following steps: updating the first value according to a clock; receiving a packet from the physical layer circuit; checking the packet; and discarding the packet when an absolute difference between the first value and the reference value is smaller than the second value.

The technical means embodied in the embodiments of the present invention can solve at least one of the problems of the prior art. Therefore, compared to the prior art, the present invention can improve the user experience and/or avoid failure of electronic devices.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a conventional electronic device.

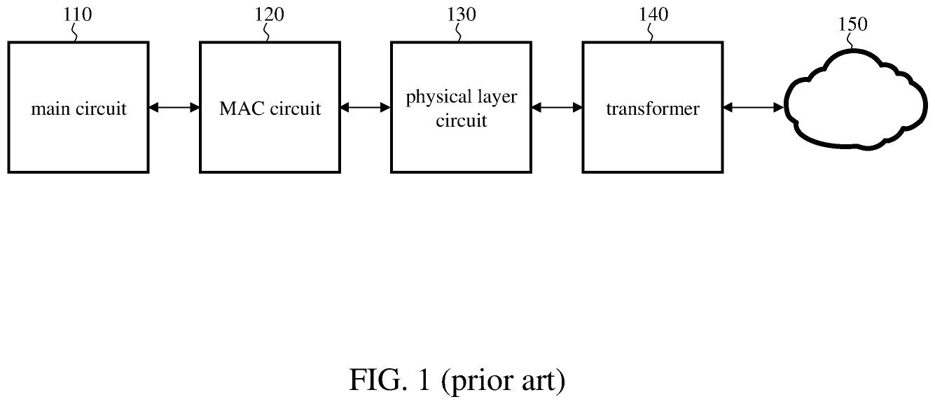

FIG. 2 shows a functional block diagram of an electronic device according to an embodiment of the present invention.

FIG. 3 shows a functional block diagram of a protection circuit according to an embodiment of the present invention.

FIG. 4 shows a functional block diagram of a token control circuit according to an embodiment of the present invention.

FIG. 5 is a flowchart of a packet management method according to an embodiment of the present invention.

FIG. 6 shows the target token quantity, token consumption quantity, step value, token reference value, and number of discarded packet(s) of several types of packets according to an aspect of the present invention.

FIG. 7 shows the detailed steps of step S534 and step S542 of FIG. 5.

FIG. 8 is an example of the operation of a media access control (MAC) circuit and the packet management method of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a media access control (MAC) circuit and a packet management method. On account of that some or all elements of the MAC circuit could be known, the detail of such elements is omitted provided that such detail has little to do with the features of this disclosure, and that this omission nowhere dissatisfies the specification and enablement requirements. Some or all of the processes of the packet management method may be implemented by software and/or firmware and can be performed by the MAC circuit or its equivalent. A person having ordinary skill in the art can choose components or steps equivalent to those described in this specification to carry out the present invention, which means that the scope of this invention is not limited to the embodiments in the specification.

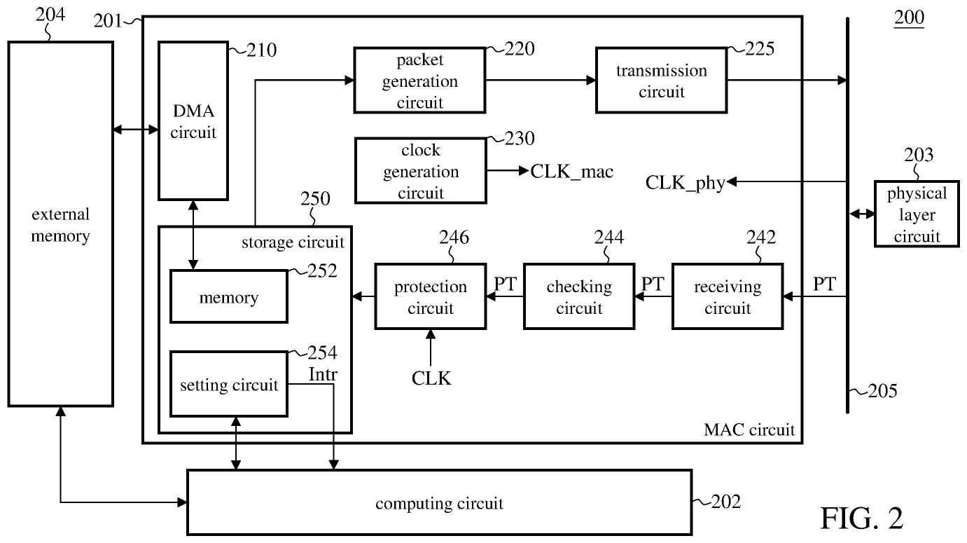

FIG. 2 shows a functional block diagram of the electronic device according to an embodiment of the present invention. The electronic device 200 includes a media access control (MAC) circuit 201, a computing circuit 202, a physical layer circuit 203, and an external memory 204. The electronic device 200 accesses the network through the MAC circuit 201 and the physical layer circuit 203. The MAC circuit 201 is coupled to the physical layer circuit 203 through the transmission interface 205 to transmit and receive data via the physical layer circuit 203. The transmission interface 205 includes but is not limited to a media-independent interface (MII), a Reduced MII (RMII), a Gigabit MII (GMII), or a Reduced GMII (RGMII).

The computing circuit 202 can be a circuit or an electronic component with program execution capability, such as a central processing unit, a microprocessor, a micro-processing unit, a digital signal processor, an Application Specific Integrated Circuit (ASIC), or their equivalent circuits. The computing circuit 202 performs all or some of the functions of the electronic device 200 by executing the program codes and/or program instructions stored in the external memory 204 (e.g., a dynamic random access memory (DRAM)).

The MAC circuit 201 includes a direct memory access (DMA) circuit 210, a packet generation circuit 220, a transmission circuit 225, a clock generation circuit 230, a receiving circuit 242, a checking circuit 244, a protection circuit 246, and storage circuit 250. The storage circuit 250 includes a memory 252 (e.g., a static random access memory (SRAM)) and a setting circuit 254 (e.g., a register). The MAC circuit 201 is used to copy or move data from the external memory 204 to the memory 252 or from the memory 252 to the external memory 204.

The computing circuit 202 is coupled to the external memory 204 and the setting circuit 254 through memory buses to access the external memory 204 and the setting circuit 254 (e.g., to change the setting value of the setting circuit 254).

The packet generation circuit 220, the transmission circuit 225, the receiving circuit 242, the checking circuit 244, and the protection circuit 246 are all coupled to the setting circuit 254, and these circuits operate according to a setting value (e.g., a register value) of the setting circuit 254. In other words, the computing circuit 202 can control the MAC circuit 201 by changing the setting value of the setting circuit 254. On the other hand, the MAC circuit 201 may send an interrupt Intr to the computing circuit 202 by changing the setting value of the setting circuit 254. For the sake of brevity, the connections between the setting circuit 254 and the packet generation circuit 220, the transmission circuit 225, the receiving circuit 242, the checking circuit 244, and the protection circuit 246 in FIG. 2 are omitted.

When the MAC circuit 201 transmits data, the packet generation circuit 220 first encapsulates the data into a packet, and then the transmission circuit 225 transmits the packet to the physical layer circuit 203 through the transmission interface 205.

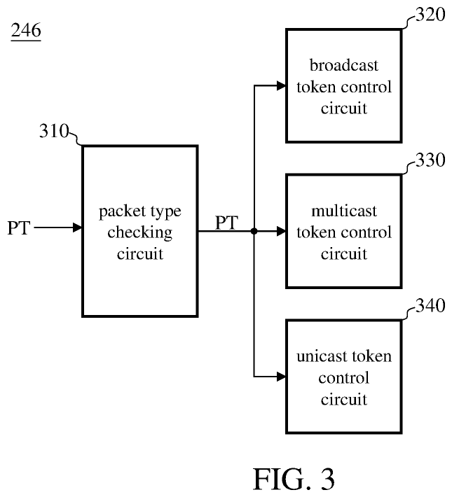

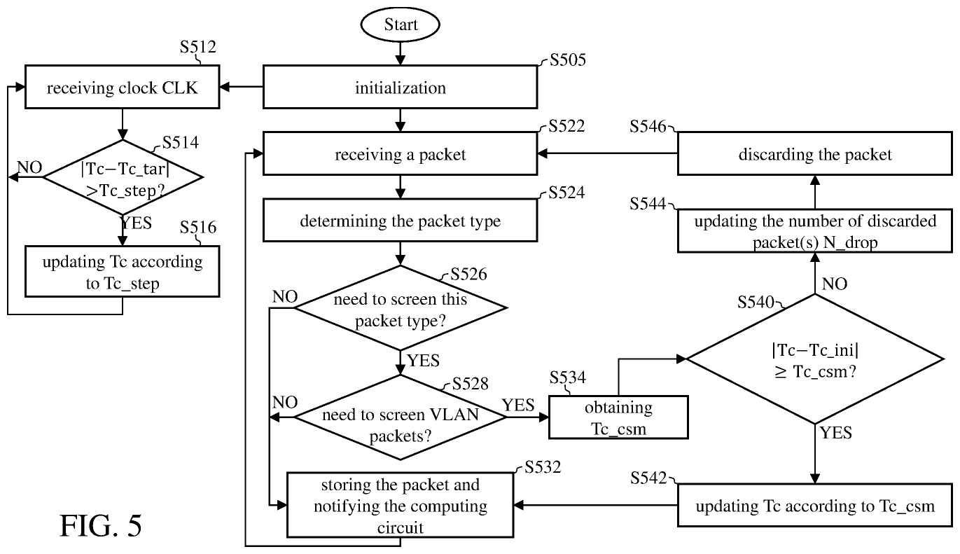

When the MAC circuit 201 receives data, the receiving circuit 242 receives the packet PT from the physical layer circuit 203 through the transmission interface 205, the checking circuit 244 checks the packet PT (including but not limited to validity checks such as length check and cyclic redundancy check (CRC)), and then the protection circuit 246 determines whether the packet PT can be accessed by the computing circuit 202. More specifically, when determining that the packet PT can be accessed by the computing circuit 202, the protection circuit 246 stores the packet PT in the memory 252 of the storage circuit 250, and then the DMA circuit 210 copies or moves the packet PT to the external memory 204 for the computing circuit 202 to read; on the other hand, when determining that the packet PT cannot be accessed by the computing circuit 202, the protection circuit 246 discards the packet PT. The detailed operation process of the protection circuit 246 will be discussed below with reference to FIG. 3 and FIG. 5.

FIG. 3 shows a functional block diagram of the protection circuit according to an embodiment of the present invention. The protection circuit 246 includes a packet type checking circuit 310, a broadcast token control circuit 320, a multicast token control circuit 330, and a unicast token control circuit 340. The packet type checking circuit 310 determines the type of the packet PT (e.g., a broadcast packet, a multicast packet, or a unicast packet) according to the content (e.g., a specific bit) of the packet PT, and sends the packet PT to the corresponding token control circuit according to the type of the packet PT. People having ordinary skill in the art can implement the packet type checking circuit 310 according to the definitions or specifications of the broadcast packet, the multicast packet, and the unicast packets, so the details are omitted for brevity.

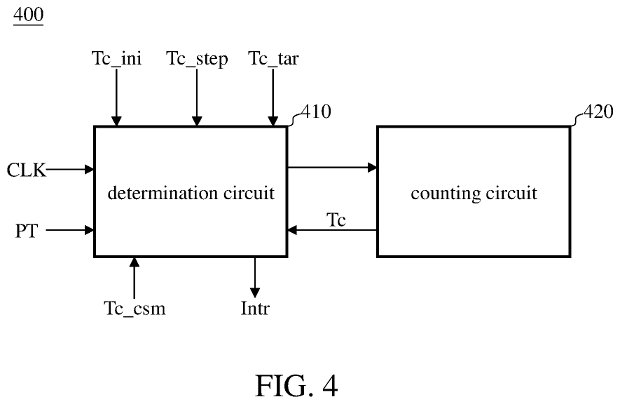

FIG. 4 shows a functional block diagram of a token control circuit according to an embodiment of the present invention. Any one of the broadcast token control circuit 320, the multicast token control circuit 330, and the unicast token control circuit 340 in FIG. 3 can be embodied by the token control circuit 400 in FIG. 4. The token control circuit 400 includes a determination circuit 410 and a counting circuit 420. The determination circuit 410 and the counting circuit 420 can be embodied by digital logic circuits.

The determination circuit 410 controls, according to the clock CLK, the current token quantity Tc, the token reference value Tc_ini, the token consumption quantity Tc_csm, the step value Tc_step, and the target token quantity Tc_tar, the counting circuit 420 to update the current token quantity Tc.

In the first embodiment, the target token quantity Tc_tar is greater than the token reference value Tc_ini, while in the second embodiment, the target token quantity Tc_tar is smaller than the token reference value Tc_ini.

When the determination circuit 410 detects the rising edge and/or falling edge of the clock CLK and the current token quantity Tc is less than (the first embodiment) or greater than (the second embodiment) the target token quantity Tc_tar, the determination circuit 410 controls the counting circuit 420 to increase (the first embodiment) or decrease (the second embodiment) the current token quantity Tc by a step value Tc_step (e.g., 1). In other words, in the first embodiment, the minimum value and the maximum value of the current token quantity Tc are respectively the token reference value Tc_ini and the target token quantity Tc_tar, whereas in the second embodiment, the minimum value and the maximum value of the current token quantity Tc are respectively the target token quantity Tc_tar and the token reference value Tc_ini.

In some embodiments, the clock CLK is the internal clock CLK_mac of the MAC circuit 201. In other embodiments, the clock CLK is the inherent clock CLK_phy of the transmission interface 205 itself. Compared to using the internal clock CLK_mac, using the clock CLK_phy can simplify the design of the electronic device 200 (because there is no need to generate an additional clock) and improve the packet counting accuracy of the electronic device 200 (because the clock CLK_phy and the packet PT belong to the same clock domain).

When the determination circuit 410 receives the packet PT, the determination circuit 410 determines whether the absolute difference between the current token quantity Tc and the token reference value Tc_ini is greater than or equal to the token consumption quantity Tc_csm. If YES, the determination circuit 410 controls the counting circuit 420 to subtract the token consumption quantity Tc_csm from the current token quantity Tc (i.e., Tc=Tc−Tc_csm, the first embodiment) or add the token consumption quantity Tc_csm to the current token quantity Tc (i.e., Tc=Tc+Tc_csm, the second embodiment), and sends the interrupt Intr to the computing circuit 202. If NO, the determination circuit 410 discards the packet PT.

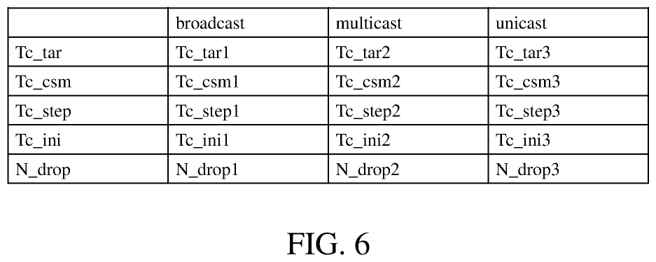

Reference is made to FIG. 5, which is a flowchart of the packet management method according to an embodiment of the present invention. The flowchart includes the following steps. Note that the broadcast token control circuit 320, the multicast token control circuit 330, and the unicast token control circuit 340 all operate according to the flowchart of FIG. 5 but may have their respective target token quantity Tc_tar, token consumption quantity Tc_csm, step value Tc_step, token reference value Tc_ini, and number of discarded packet(s) N_drop, as shown in FIG. 6.

Step S505 is an initialization step, in which the determination circuit 410 sets the current token quantity Tc to the token reference value Tc_ini (e.g., 0) and sets the number of discarded packet(s) N_drop to an initial value (e.g., 0).

Step S512: The determination circuit 410 receives the clock CLK and performs step S514 when the clock CLK transitions.

Step S514: The determination circuit 410 determines whether the absolute difference between the current token quantity Tc and the target token quantity Tc_tar is greater than the step value Tc_step. If YES (i.e., Tc_tar−Tc>Tc_step (the first embodiment) or Tc-Tc_tar>Tc_step (the second embodiment)), then the flow proceeds to step S516; if NO (indicating that the current token quantity Tc is equal to or close to the target token quantity Tc_tar), the flow returns to step S512.

Step S516: The token control circuit 400 updates the current token quantity Tc according to the step value Tc_step. More specifically, the determination circuit 410 controls the counting circuit 420 to increase the current token quantity Tc by the step value Tc_step (i.e., Tc=Tc+Tc_step, the first embodiment) or decrease the current token quantity Tc by the step value Tc_step (i.e., Tc=Tc−Tc_step, the second embodiment). In some embodiments, the step value Tc_step is 1.

In short, after the initialization step S505, the token control circuit 400 adjusts the current token quantity Tc according to the clock CLK (steps S512-S516), and in the meantime, the packets are managed (the packets are either sent to the computing circuit 202 or discarded, which is detailed below with reference to steps S522-S546).

Step S522: The protection circuit 246 receives a packet PT. As shown in FIG. 2, the packet PT has already been checked by the checking circuit 244.

Step S524: The packet type checking circuit 310 determines the packet type, that is, determines whether the packet PT is a broadcast packet, a multicast packet, or a unicast packet according to the content of the packet PT.

Step S526: The packet type checking circuit 310 determines whether to filter this packet type. More specifically, the computing circuit 202 can determine which type(s) of packets need(s) to be filtered and/or which type(s) of packets do(es) not need to be filtered by controlling the setting circuit 254. For example, in a case where the broadcast packets need to be filtered and the multicast packets and the unicast packets do not need to be filtered, the protection circuit 246 sends the packet PT to the computing circuit 202 (i.e., performs step S532) when the packet PT is not a broadcast packet, and performs step S528 when the packet PT is a broadcast packet.

Step S528: The protection circuit 246 determines whether to filter packets from a virtual local area network (VLAN). More specifically, when the packet PT is not a VLAN packet, the protection circuit 246 sends the packet PT to the computing circuit 202 (i.e., performs step S532); when the packet PT is a VLAN packet, the protection circuit 246 performs step S534.

Step S532: The protection circuit 246 stores the packet PT in the memory 252, notifies the computing circuit 202 with the interrupt Intr, and then returns to step S522 to receive a next packet. Because the packet PT stored in the memory 252 is copied or moved to the external memory 204 by the DMA circuit 210, step S532 is equivalent to the protection circuit 246 storing the packet PT in the external memory 204. The computing circuit 202 may read the packet PT from the external memory 204 in response to the interrupt.

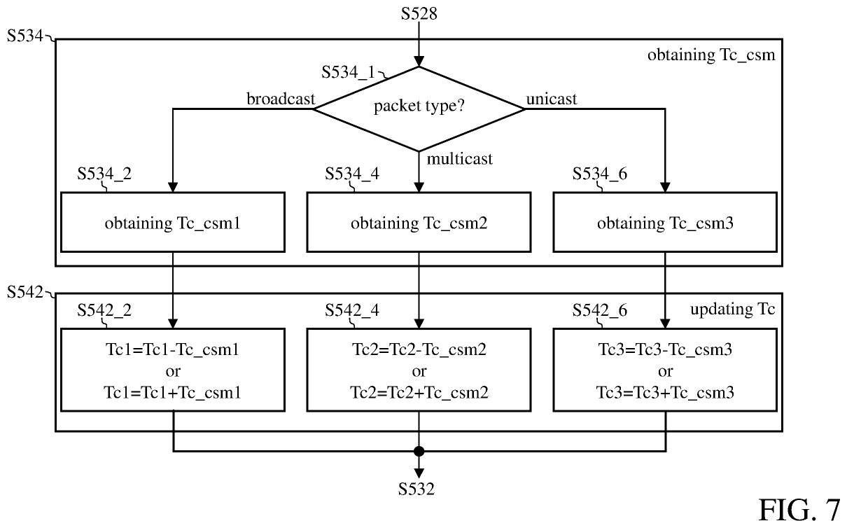

Step S534: The token control circuit 400 obtains the token consumption quantity Tc_csm. The details of this step will be discussed below with reference to FIG. 7.

Step S540: The determination circuit 410 determines whether the absolute difference between the current token quantity Tc and the token reference value Tc_ini is greater than or equal to the token consumption quantity Tc_csm (which is equivalent to determining whether the current token quantity Tc is sufficient). If YES (indicating that the current token quantity Tc is sufficient), the current token quantity Tc is updated according to the token consumption quantity Tc_csm (step S542), and then the packet is sent to the computing circuit 202 (step S532); if NO, the packet is discarded (steps S544, S546).

Step S542: The determination circuit 410 controls the counting circuit 420 to update the current token quantity Tc to Tc=Tc−Tc_sum (the first embodiment) or Tc=Tc+Tc_sum (the second embodiment). The details of this step will be discussed below with reference to FIG. 7.

Step S544: The determination circuit 410 updates the number of discarded packet(s) N_drop, for example, adds 1 to the number of discarded packet(s) N_drop.

Step S546: The protection circuit 246 discards the packet PT, that is, does not store the packet PT in the memory 252, which is equivalent to not allow the packet PT to be stored in the external memory 204, which is also equivalent to not send the packet PT to the computing circuit 202. As a result, the computing circuit 202 cannot obtain the packet PT. After step S546 finishes, the flow returns to step S522 to receive the next packet.

Reference is made to FIG. 7, which shows the detailed steps of step S534 and step S542. It is assumed that the current token quantity Tc is sufficient (i.e., the result of step S540 is YES).

The packet type checking circuit 310 first determines whether the packet PT is a broadcast packet, a multicast packet, or a unicast packet (step S534_1).

When the packet PT is a broadcast packet, the broadcast token control circuit 320 obtains the broadcast token consumption quantity Tc_csm1 from the storage circuit 250 (step S534_2), and then the counting circuit 420 of the broadcast token control circuit 320 updates the current token quantity for broadcast packets Tc1 to Tc1−Tc_csm1 (the first embodiment) or Tc1+Tc_csm1 (the second embodiment) in step S542_2.

When the packet PT is a multicast packet, the multicast token control circuit 330 obtains the multicast token consumption quantity Tc_csm2 from the storage circuit 250 (step S534_4), and then the counting circuit 420 of the multicast token control circuit 330 updates the current token quantity for multicast packets Tc2 to Tc2−Tc_csm2 (the first embodiment) or Tc2+Tc_csm2 (the second embodiment) in step S542_4.

When the packet PT is a unicast packet, the unicast token control circuit 340 obtains the unicast token consumption quantity Tc_csm3 from the storage circuit 250 (step S534_6), and then the counting circuit 420 of the unicast token control circuit 340 updates the current token quantity for unicast packets Tc3 to Tc3−Tc_csm3 (the first embodiment) or Tc3+Tc_csm3 (the second embodiment) in step S542_6.

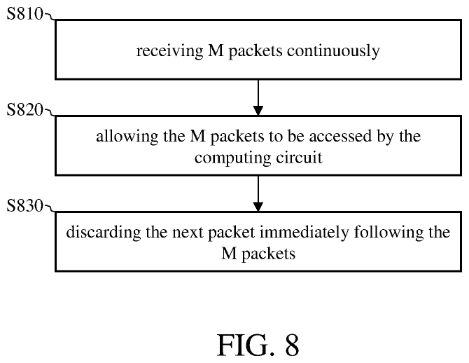

As can be seen from the above discussions, when the current token quantity Tc is equal to the target token quantity Tc_tar, the protection circuit 246 allows the computing circuit 202 to receive at most M packets continuously, where M=(Tc_tar−Tc_ini)/Tc_csm (the first embodiment) or M=(Tc_ini−Tc_tar)/Tc_csm (the second embodiment). The details are shown in the flowchart of FIG. 8.

Step S810: The protection circuit 246 receives M packets continuously.

Step S820: The protection circuit 246 allows the M packets to be accessed by the computing circuit 202; that is, the protection circuit 246 stores the M packets in the external memory 204, which is equivalent to performing step S532 of FIG. 5 M times.

Steps S810-S820 are equivalent to continuously performing steps S522-S542 of FIG. 5 M times until the result of step S540 is NO, that is, until Tc-Tc_ini<Tc_csm (the first embodiment) or Tc_ini−Tc<Tc_csm (the second embodiment).

Step S830: The protection circuit 246 discards the next packet immediately following the M packets, that is, does not allow the next packet immediately following the M packets to be sent to the computing circuit 202. Because the M consecutive packets have consumed all or almost all of the current token quantity Tc in steps S810 and S820, the protection circuit 246 discards the next packet (i.e., steps S544, S546) to protect the computing circuit 202.

FIG. 8 is an example of the operation of the MAC circuit and the packet management method of the present invention, illustrating how the protection circuit 246 prevents the computing circuit 202 from continuously receiving more than M packets. In other words, the maximum number of packets that the computing circuit 202 can continuously receive at an instant is M, and the manufacturer, developer, or user of the electronic device 200 can change M by adjusting the token reference value Tc_ini, the target token quantity Tc_tar, and/or the token consumption quantity Tc_csm.

For example, if the token consumption quantity Tc_csm is 40,000 and |Tc_ini−Tc_tar|=40,000,000, then for a 100M Ethernet network using the MII (the receiving clock is 25 MHZ), the computing circuit 202 receives at most 625 (=25M/40000) packets per second, and receives at most 1000 (=40000000/40000) packets continuously at an instant; for a 100M Ethernet network using the RMII (the receiving clock is 50 MHz), the computing circuit 202 receives at most 1250 (=50M/40000) packets per second, and receives at most 1000 (=40000000/40000) packets continuously at an instant.

In some embodiments, the current token quantity Tc, the step value Tc_step, the token consumption quantity Tc_csm, the target token quantity Tc_tar, the token reference value Tc_ini, and the number of discarded packet(s) N_drop can be stored in the storage circuit 250.

In other embodiments, step S526 of FIG. 5 may be performed by the checking circuit 244 instead of the protection circuit 246. When the checking circuit 244 determines that the type of the packet PT is a packet type that does not need to be filtered, the checking circuit 244 directly performs step S532, so that the protection circuit 246 does not need to process the packet PT.

The broadcast packets, multicast packets, and unicast packets are intended to illustrate the invention by way of example and not to limit the scope of the claimed invention. People having ordinary skill in the art may apply the present invention to other types of packets in accordance with the foregoing discussions.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A media access control (MAC) circuit coupled to a physical layer circuit, comprising:
a storage circuit configured to store a first value and a second value;
a receiving circuit configured to receive a packet from the physical layer circuit;
a checking circuit configured to check the packet; and
a protection circuit configured to perform following steps:
updating the first value according to a clock; and
discarding the packet when an absolute difference between the first value and a reference value is smaller than the second value.

2. The MAC circuit of claim 1, wherein the MAC circuit is further coupled to a computing circuit, and the protection circuit further performs following steps:
allowing the packet to be accessed by the computing circuit and updating the first value according to the second value when the absolute difference between the first value and the reference value is greater than or equal to the second value.

3. The MAC circuit of claim 2, wherein the MAC circuit is further coupled to an external memory, when the absolute difference between the first value and the reference value is greater than or equal to the second value, the MAC circuit stores the packet in the external memory and sends an interrupt to the computing circuit.

4. The MAC circuit of claim 2, wherein when the first value is equal to a target value, the protection circuit stops updating the first value according to the clock.

5. The MAC circuit of claim 4, wherein the protection circuit allows at most M consecutive packets to be accessed by the computing circuit, and M is a quotient of an absolute difference between the target value and the reference value divided by the second value.

6. The MAC circuit of claim 5, wherein the protection circuit discards a next packet immediately following the M packets.

7. The MAC circuit of claim 2, wherein the step of updating the first value according to the second value is updating the first value to a difference between the first value and the second value or a sum of the first value and the second value.

8. The MAC circuit of claim 2, wherein the protection circuit further performs following steps:
determining a packet type of the packet; and
determining the second value according to the packet type of the packet.

9. The MAC circuit of claim 8, wherein the packet type comprises a broadcast packet, a multicast packet, and a unicast packet.

10. The MAC circuit of claim 1, wherein the MAC circuit is coupled to the physical layer circuit through a transmission interface, and the MAC circuit receives the clock from the transmission interface.

11. A packet management method applied to a media access control (MAC) circuit, wherein the MAC circuit is coupled to a physical layer circuit and comprises a storage circuit that stores a first value, a second value, and a reference value, the method comprising:
updating the first value according to a clock;
receiving a packet from the physical layer circuit;
checking the packet; and
discarding the packet when an absolute difference between the first value and the reference value is smaller than the second value.

12. The method of claim 11, wherein the MAC circuit is further coupled to a computing circuit, the method further comprising:
allowing the packet to be accessed by the computing circuit and updating the first value according to the second value when the absolute difference between the first value and the reference value is greater than or equal to the second value.

13. The method of claim 12, wherein the MAC circuit is further coupled to an external memory, the method further comprising:
storing the packet in the external memory and sending an interrupt to the computing circuit when the absolute difference between the first value and the reference value is greater than or equal to the second value.

14. The method of claim 12 further comprising:
stopping updating the first value when the first value is equal to a target value.

15. The method of claim 14 further comprising:
allowing at most M consecutive packets to be accessed by the computing circuit;
wherein M is a quotient of an absolute difference between the target value and the reference value divided by the second value.

16. The method of claim 15 further comprising:
discarding a next packet immediately following the M packets.

17. The method of claim 12, wherein the step of updating the first value according to the second value is updating the first value to a difference between the first value and the second value or a sum of the first value and the second value.

18. The method of claim 12 further comprising:
determining a packet type of the packet; and
determining the second value according to the packet type of the packet.

19. The method of claim 18, wherein the packet type comprises a broadcast packet, a multicast packet, and a unicast packet.

20. The method of claim 11, wherein the MAC circuit is coupled to the physical layer circuit through a transmission interface, and the MAC circuit receives the clock from the transmission interface.
